(19) United States
(12) Patent Application Publication
(10) Pub. No.: US 2006/0161839 A1
(43) Pub. Date: Jul. 20, 2006

(54) Method for obtaining communication settings using an application descriptor

(76) Inventor: Claus Pedersen, Vallensbaek (DK)

Correspondence Address: HARRINGTON & SMITH, LLP, 4 RESEARCH DRIVE, SHELTON, CT, 06484-6212, US

(21) Appl. No.: 10/559,034

(22) PCT Filed: Jun. 25, 2003
(86) PCT No.: PCT/IB03/02948

§ 371 Date: Nov. 29, 2005

(51) Int. Cl. G06F 17/21

(52) U.S. Cl. 715/513; 709/218

(57) ABSTRACT

A method of communicating in connection with a MIDlet including the steps of obtaining at least one communication setting from a provisioning document associated with the MIDlet; and communicating, in connection with the MIDlet, using the at least one setting.

### TECHNICAL FIELD

Embodiments of the present invention relate to communication in connection with software applications. They particularly relate to communication in connection with software applications in mobile telephones.

### BACKGROUND TO THE INVENTION

Mobile phones are currently able to run downloaded external applications as well as preinstalled embedded applications. The external application may be a platform independent application that runs on a resident virtual machine in the phone. Java™ applications are the preferred form of platform independent applications.

Java2 Micro Edition (J2ME) defines a Mobile Information Device Profile (MIDP) for mobile phones and similar handheld devices that have constraints on their user interfaces and system components such as processing power and memory size. MIDP is currently at version 2.0. Software applications that conform to MIDP are called MIDlets and are downloaded as part of a MIDlet suite.

A MIDlet suite has two separate parts. The first, the Java Application Descriptor (JAD), describes the applications in the suite and is identified by a data file name with a “.jad” extension. The second, the Java Application Resource (JAR) contains the actual applications (the MIDlets) and it is identified by a data file name with a “.jar” extension. The JAD allows the suitability of the application to be reviewed, by the user of the downloading device or the device itself, before the full JAR file is downloaded.

The JAD comprises a predetermined set of attributes that allow the downloading device to identify, retrieve, and install the MIDlet(s). The format of the application descriptor (JAD) is a sequence of lines consisting of an attribute name followed by a colon, the value of the attribute, and a carriage return. White space is ignored before and after the attribute and the order of the attributes is arbitrary.

The Java Application Descriptor (JAD) of a MIDlet suite must contain the following set of attributes:

MIDlet-Name:

MIDlet-Version:

MIDlet-Vendor

MIDlet-Jar-URL:

MIDlet-Jar-Size:

The Mobile Information Device Profile (MIDP) does not enable any control over how the mobile device perform over the air communication. It assumes that over the sir access is available. However, in some situations access may not be available or a MIDlet may require access to a particular point of the network or access via a particular server. Furthermore, the access may need to be in accordance with a particular protocol.

It would be desirable to enable control over the manner in which a mobile device performs over the sir communication in connection with a MIDlet.

The inventors have realized that the modification of the MIDP to achieve this would be difficult. They have realized that, the problem can be addressed and overcome by using a mechanism devised for Wireless Application Protocol (WAP).

The Open Mobile Alliance currently controls the Wireless Application Protocol (WAP). A number of specification documents have been published, which define how WAP should operate. These specifications include Provisioning Content Specification V1.1 (Draft Version 20-Sept-2002) and WAÅ-(WAP)189-PushOTA.

A wireless application protocol (WAP) network comprises a number of clients, servers and proxy gateways that mediate between a client and server.

WAP supports “pull” and “push” technology. In “pull” technology, a client requests a service or information from a server, which then responds by transmitting information to the client. Browsing the World Wide Web is a typical example of pull technology. In “push” technology, the server sends information to the client without an explicit request i.e. it is server initiated.

Provisioning is a process by which a WAP client is configured to perform a service with a minimum of user interaction on receipt of a provisioning document.

### BRIEF SUMMARY OF THE INVENTION

According to one aspect of the present invention there is provided a method of communicating in connection with a MIDlet comprising the steps of: obtaining at least one communication setting from a provisioning document associated with the MIDlet; and communicating, in connection with the MIDlet, using the at least one setting.

According to another aspect of the present invention there is provided a method of over the air communication in connection with an application, comprising the steps of: obtaining an identifier from an application descriptor; obtaining, from a provisioning document including the identifier, at least one communication setting; and using the at least one communication setting to communicate in connection with the application referenced by the application descriptor.

According to a further aspect of the present invention there is provided a method of controlling communication in connection with a MIDlet comprising the steps of: providing a provisioning document including an identifier from the JAD of the MIDlet and at least one setting for controlling communication in connection with the MIDlet.

According to another aspect of the present invention there is provided a mobile telephone device comprising: means for obtaining an identifier from an application descriptor; means for obtaining, from a provisioning document including the identifier, at least one setting for over the air communication; and transceiver means for over the air communication, using the at least the one setting, in connection with the application referenced by the application descriptor.

Embodiments of the present invention associate a provisioning document with the JAD of a MIDlet suite. The content of the provisioning document controls how over the air communication in connection with that MIDlet is performed. It may, for example, specify one or more of an application protocol, a proxy or a network access point.

### BRIEF DESCRIPTION OF THE DRAWINGS

For a better understanding of the present invention and to understand how the invention can be practised reference will now be made by way of example only to the accompanying drawings of embodiments of the invention in which:

FIG. 1 illustrates a hand-portable device operable in accordance with the invention; and

FIG. 2 illustrates a process according to one embodiment of the invention.

### DETAILED DESCRIPTION OF EMBODIMENTS(S) OF THE INVENTION.

Embodiments of the present invention relate to the association of a JAD with a provisioning document to enable control of how an application (MIDlet) within the MIDlet suite incorporating the JAD performs over the air communication. The content of the provisioning document controls how the communication occurs. It may, for example, specify one or more of an application protocol, a proxy or a network access point.

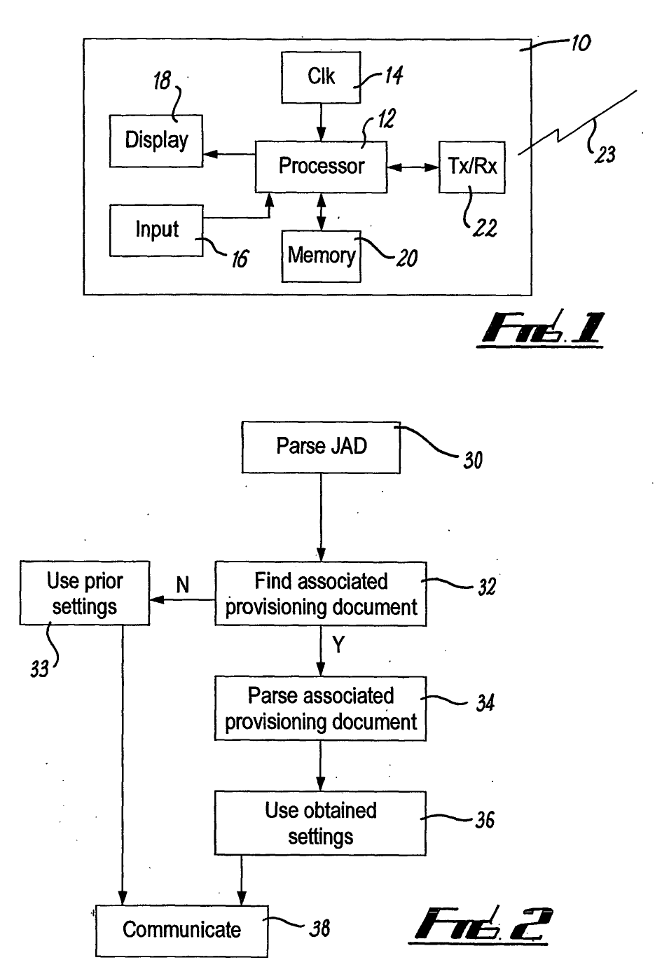

FIG. 1 schematically illustrates one-type of suitable hand-portable device 10 for downloading and running an application via a MIDlet suite. The hand-portable device comprises a microprocessor 12, which receives inputs from a clock 14 and an input device 16. The microprocessor 12 provides an output via a display 18, and is connected to write to and read from a non-volatile memory 20. It is also capable of communicating with a server, storing a MIDlet suite, via a wireless transceiver 22.

The input device 16 may be a one-handed entry keyboard such as the ITU-T phone keyboard, a two-handed entry keyboard such as a QWERTY keyboard, or a touch entry device. The wireless transceiver 22 may be any suitable remote communication means. It may be a cellular radio telephone transceiver for operating in a cellular radio telephone network, it may be a Bluetooth™ transceiver or it may be an IR transceiver. The hand-portable device 10 may be a WAP enabled cellular mobile telephone that is arranged to download MIDlet suites using the WAP Protocol.

The non-volatile memory 20 stores software which enables the Java Virtual Machine. The Java Virtual Machine is capable of downloading a MIDlet suite via the transceiver 22, storing the MIDlet suite in the memory 20 and running applications (MIDlets) contained in MIDlet suite.

A MIDlet suite has two separate parts. The first, the Java Application Descriptor (JAD), describes the applications in the suite and is identified by a data file name with a “.jad” extension. The second, the Java Application Resource (JAR) contains the actual application(s) (the MIDlet(s)) and it is identified by a data file name with a “.jar” extension. The JAD allows the suitability of the application to be reviewed, by the user of the downloading device or the device itself, before the full JAR is downloaded.

The JAD comprises a predetermined set of attributes that allow the downloading device to identify, retrieve, and install the MIDlet(s). The Java Application Descriptor (JAD) of a MIDlet suite contains the following set of attributes:

MIDlet-Name:

MIDlet-Version:

MIDlet-Vendor

MIDlet-Jar-URL:

MIDlet-Jar-Size:

The MIDlet-Name gives the name by which the MIDlet suite is identified to the user before download. The MIDlet-Jar-URL gives the URI from which the JAR is to be downloaded.

The JAR may be pre-installed or loaded into the mobile telephone. If it is loaded into the telephone this may occur via a physical device such as a smart card or over-the-air, such as via the transceiver 22 e.g. using SMS (short message service).

The device 10 is provisioned with an adapted provisioning document. Provisioning is the process by which the device 10 is configured with a minimum of user interaction. The term covers both over the air (OTA) provisioning and provisioning by means of, e.g. smart cards. The device 10 may, for example, be provisioned with connectivity and application information by pushing configuration parameters contained in a provisioning document over the air from a server to the device 10.

An adapted provisioning document is a binary encoded XML document with a special MIME type that is interpreted at the application level of the device 10. The XML Document Type Definition (DTD) for a provisioning document defines two elements: a parm element, which is used to provide values for the individual parameters; and a characteristic element, which is used to group parameters into logical entities.

The adapted provisioning document may be, for example,:

<wap-provisioningdoc version=“1.1”>
<characteristic type = “APPLICATION”>

<parm name= “APPID” value= “[MIDlet-Name]” />
<parm name= “TO-NAPID” value= “NAP1”/>
<parm name= “TO-PROXY” value= “www.operator.com”/>
</characteristic>

<characteristic type = “NAPDEF”>

<parm name= “NAPID” value= “NAP1”/>
.....

</characteristic>
</wap-provisioningdoc>

This adapted provisioning document is associated with a particular MIDlet suite and it specifies the manner by which the MIDlets for that MIDlet suite shall perform over the air communication. The association in this example is by setting the value of APPID to MIDlet-Name in the JAD.

In the provisioning document, the APPLICATION characteristic is used to define application protocol parameters and to provide application specific parameters that the device 10 needs to access a particular application service access point e.g. a server storing the JAR.

The APPID element would in a ‘normal’ provisioning document identify the type of application service available at the described application service access point, but in this adapted example it is used to associate to the JAD. The association in this example is by setting the value of APPID to MIDlet-Name in the JAD but it could alternatively be set to MIDlet-Jar-URL.

The TO-PROXY parameter refers to a logical proxy with a matching PROXY-ID that should be used to access the MIDlet-Jar-URL. In this example, it is the proxy of the network operator. This may, for example, enable charging for the download service.

The TO-NAPID parameter refers to the network access point definition with a matching NAPID parameter. The NAPDEF characteristic includes the parameter NAPID, the value of which links to the value of TO-NAPID in the APPLICATION characteristic. The NAPDEF characteristic includes all the parameters needed to access the data network. e.g. bearer, NAP address such as e.g. a telephone number etc. A NAP (Network Access Point) specifies a particular interface between the wireless network and the wired network.

The provisioning document may be downloaded via the MGMT Server (Terminal management server) or a bootstrap process may be performed.

The device 10 operates in accordance with the process illustrated in FIG. 2.

At step 30, the device 10 parses the JAR to determine the value of MIDlet-Name. This is an identifier of the MIDlet.

At step 32, the device finds the associated adapted provisioning document with the value of APPID equal to the identifier of the MIDlet, in this case the value of MIDlet-Name.

If the device fails to find an associated provisioning document, it attempts at step 33 to perform over the air communication using the same mechanism and settings as used to download the MIDlet suite (if any).

At step 34, the device parses the provisioning document to determine the network access point and/or application protocol and/or proxy settings for downloading the JAR referred to by the JAD.

At step 36, the device sets the network access point and/or application protocol and/or proxy settings to the value(s) specified in the adapted provisioning document.

At step 38, the device performs over the air communication using the settings from step 36 or step 33 as appropriate.

The method may be performed by a computer program that includes executable instructions. The computer program may be stored on a data storage medium or downloaded over the air. It may be used to upgrade an existing mobile telephone so that it can perform the above described method

Although embodiments of the present invention have been described in the preceding paragraphs with reference to various examples, it should be appreciated that modifications to the examples given can be made without departing from the scope of the invention as claimed. For example although the invention has been described in the context of downloading an application to a hand-portable device, it may also be used to download applications to other devices such as a desktop computer.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A method of communicating in connection with a MIDlet comprising the steps of:
obtaining at least one communication setting from a provisioning document associated with the MIDlet; and
communicating, in connection with the MIDlet, using the at least one setting.

2. A method as claimed in claim 1, wherein the provisioning document is associated with the MIDlet by the inclusion of an identifier of the MIDlet in the provisioning document.

3. A method as claimed in claim 2, wherein provisioning document includes the identifier as the value of APPID.

4. A method as claimed in claim 2, wherein the identifier includes the value of MIDlet-Name and/or the value of MIDlet-Jar-URL of the JAD of the MIDlet.

5. A method as claimed in claim 2, further comprising the step of obtaining the identifier of the MIDlet from the JAD.

6. A method as claimed in claim 1, further comprising the step of communicating, in connection with the MIDlet, using the at least one setting for over the air communication.

7. A method as claimed in claim 6, wherein the step of communicating over the air occurs after the JAR of the MIDlet has been received.

8. A method as claimed in claim 6, wherein the step of communicating over the air occurs in relation to an application provided by the MIDlet.

9. A method as claimed in claim 1 wherein the at least one setting identifies at least an application protocol.

10. A method as claimed in claim 1 wherein the at least one setting identifies at least a network access point.

11. A method of over the air communication in connection with an application, comprising the steps of:
obtaining an identifier from an application descriptor;
obtaining, from a provisioning document including the identifier, at least one communication setting; and
using the at least one communication setting to communicate in connection with the application referenced by the application descriptor.

12. A method as claimed in claim 11, wherein the at least one setting identifies at least an application protocol.

13. A method as claimed in claim 11, wherein the at least one setting identifies at least a network access point.

14. A data storage medium embodying a computer program for performing the method of claims 11.

15. A data storage medium embodying a computer program for performing the method of claim 12.

16. A data storage medium embodying a computer program for performing the method of claim 13.

17. A method of controlling communication in connection with a MIDlet comprising the steps of:
providing a provisioning document including an identifier from the JAD of the MIDlet and at least one setting for controlling communication in connection with the MIDlet.

18. A mobile telephone device comprising:
means for obtaining an identifier from an application descriptor;
means for obtaining, from a provisioning document including the identifier, at least one setting for over the air communication; and
transceiver means for over the air communication, using the at least the one setting, in connection with the application referenced by the application descriptor.
